(19) United States
(12) Patent Application Publication
(10) Pub. No.: US 2016/0277869 A1
(43) Pub. Date: Sep. 22, 2016

(54) METHOD AND PROGRAM PRODUCT FOR LOCATION BASED CUSTOMER AND VENDOR DIRECT CONNECTIVITY

(71) Applicant: Yakub Mulayev, Palmdale, CA (US)

(72) Inventor: Yakub Mulayev, Palmdale, CA (US)

(21) Appl. No.: 14/662,453

(22) Filed: Mar. 19, 2015

(51) Int. Cl. H04W 4/00; H04W 4/20

(52) U.S. Cl. CPC H04W 4/003; H04W 4/20

(57) ABSTRACT

A method comprises connecting to an application platform comprising a plurality of modules being configured to network a plurality of clients for a plurality of vendors. A request for a service is submitted. The request at least comprises a customer's identity, a location for the service and a type of the service. The application platform determines a list of available vendors located within a geographical distance from the location. A customer's choice of a vendor is submitted. The application platform communicates the request to the chosen vendor and facilitates communication between the customer and the chosen vendor, wherein, upon agreement between the customer and the chosen vendor, the chosen vendor dispatches to the location. A request for materials needed by the vendor to complete the service is submitted. The materials are dispatched to the location while the vendor is at the location.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to vendor services. More particularly, one or more embodiments of the invention generally relate to direct, location-based, customer/vendor connectivity and interactive services.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

By way of educational background, another aspect of the prior art generally useful to be aware of is that, the art presupposes a group of customers traveling in a certain area and direction and will allow them to connect via social media and anonymously try to request bids, or get a discounted rate from geographically centered vendors. In other embodiments, a vendor data module stores data related to a plurality of vendors registered with a broker server. For example, the vendor data module preferably stores location information associated with each vendor (e.g., zip codes) and line card information associated with each vendor (e.g., what types of products the vendor sells and what kinds of manufacturers the vendor carries). When locating vendors, the broker server preferably performs a geographical expansion search as described in detail below. Similarly, the geographic expansion module may determine the distance between the first zip code and the third zip code by using the global latitude/longitude coordinates associated with the first zip code and the third zip code. These two distances (1st zip to 2nd zip and 1st zip to 3rd zip) may then be compared to determine which distance is shorter. A vendor registration web page determines if the customer locates a vendor able to meet the customer's needs, the customer may then select the vendor to complete the purchase via the broker server. If the customer locates a vendor able to meet the customer's needs, the customer may select the vendor to complete the purchase via the server.

In another aspect of the prior art, Online Marketplace for Real Estate Solutions is a website operating system. The Web site system facilitates online collaboration for real estate transactions. Embodiments of the marketplace for real estate solutions provide improved information and tools and ways for agents and consumers to connect, providing mechanisms that allow vendors to harness the power of their networks. Embodiments of the invention comprise an online open marketplace for real estate and related services. Also, the marketplace provides the ability for direct property transactions among members.

Agents may register by providing an email address, creating a username and password, and providing full contact information (name, address, phone, etc.) as well as a valid real estate agent identification number (e.g., real estate license number). In other embodiments, initiating a user login process and, receiving at the web site system, a service provider selection, whereby the selection specifies a service provider associated with the real estate agent. Thus, a search for a real estate agent would involve criteria such as customer ratings, number of transactions, type of services provided, discipline of specialization, geographic location, and languages spoken. Finally, consumers may publish a message into the network indicating their desire to be contacted by any agent that can accommodate a particular request such as conducting a tour of a given home at a particular time.

By way of educational background, another aspect of the prior art generally useful to be aware of is that, the art focuses on vendors posting part numbers online and customers logging in requesting a certain part. In another aspect of the prior art, techniques which allow potential customers that may be travelling near a vendor to propose a discounted group purchase offer to the vendor. In other embodiments, using one or more computers, a group of potential customers may be presented with a list of the one or more nearby vendors. The group of one or more potential customers may be allowed to communicate with each other over the virtual social network to collaborate on a discounted group purchase offer. In some embodiments, the group may be presented with a list of nearby vendors, and may also include additional information on the vendors (e.g., hours of operation, menus, prices, current promotions, etc.). The group may collaborate on which vendor(s) to select, and on the terms of the group purchase offer. At step 404, using one or more computers, one or more vendors within a predetermined distance from the group of potential customers may be detected. Another example is a family traveling in a van, which is low on gas. They log-in to the system and connect with other travelers.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary geographical view of an exemplary software module architecture of a networking platform system, in accordance with an embodiment of the present invention;

FIGS. 2A and 2B illustrate an exemplary software module architecture of a system for networking application platform that enables the delivery options availability of services, materials/tools and products, in accordance with an embodiment of the present invention;

FIG. 3 illustrates an exemplary software module architecture of a system for networking application platform that enables a user/customer to select recommended options for their service desired, in accordance with an embodiment of the present invention;

FIG. 4 illustrates an exemplary software module architecture of a system for networking application platform that enables individuals or a plurality of websites to perform based vendor services, in accordance with an embodiment of the present invention;

FIGS. 5A and 5B illustrates an exemplary software module architecture of a system for networking application platform that enables geographically based of matched connectivity of vendor and customer or buyers and sellers to match criteria of what they are looking to sell or buy, in accordance with an embodiment of the present invention;

FIG. 6 illustrates an exemplary software module architecture of a system for networking application platform that enables user/customers and vendors to communicate about projects and services, in accordance with an embodiment of the present invention;

FIG. 7 illustrates an exemplary software module architecture of a system for networking application platform for a web-enabled/networked application platform by which a client/server system may be used in accordance with an embodiment of the present invention;

FIG. 8 illustrates an exemplary software module architecture of a system for networking application platform depicting a services delivery system, in accordance with an embodiment of the present invention;

FIG. 9 illustrates an exemplary software module architecture of a system for networking application platform depicting a conventional client/server communication system, in accordance with an embodiment of the present invention; and

FIG. 10 is a flow chart illustrating an exemplary process for signing up for a location-based vendor service provider, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### TERMINOLOGY

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks. “

Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention may provide means and methods for providing real time location-based vendor services as mobile applications on cell phones, computing devices, and other mobile devices. The software for some embodiments may be coded for all mobile phone operating systems including, but not limited to, Symbian, Windows Mobil, Brew, iPhone, Android, and Blackberry. In some embodiments the software may be coded for all computer operating systems. In some embodiments location data of each mobile or computing device in the system may be kept in a central secure database unique to this system. The geographical location data in this database may then be used to provide location based vendor services such as, but not limited to, emergency vehicle services, residential and commercial building services, personal care services, and parts/equipment and medicinal drug delivery services. Some embodiments of the present invention may also enable companies or any individual to provide their own location based vendor services. In some embodiments, the solution (i.e., the software and hardware) may be architected to accommodate 1,000,000 users; however, alternate embodiments may be scaled to pluralities of millions of users effectively.

In one embodiment, another type of location-based vendor service may be resource tracking. For example, without limitation, a business owner may track his resources such as, but not limited to, delivery drivers, electrical and mechanical vendor services for commercial and residential properties, taxis, service people, rental equipment, property rental, fleet management and scheduling, and personal vendors. In one embodiment, another type of location-based vendor service may be an alert such as, but not limited to, an alert of vendors in the customers geographical location that are available for service based upon a customer's signal of desired service. In one embodiment, alerts may provide information to users and vendors.

Geographically based vendor services is a huge market and the approaches provided by some embodiments of the present invention offer companies and users an easy way to provide location-based vendor services to their customers. Furthermore, location-based vendor service providers may be able to generate revenue from location-based signal text message ads to users and ads on the websites associated with the location-based vendor services. The use of location-based vendor services according to some embodiments may enable companies to provide more timely delivery of products and material and location-based networking application services that are much more relevant and timely to the user.

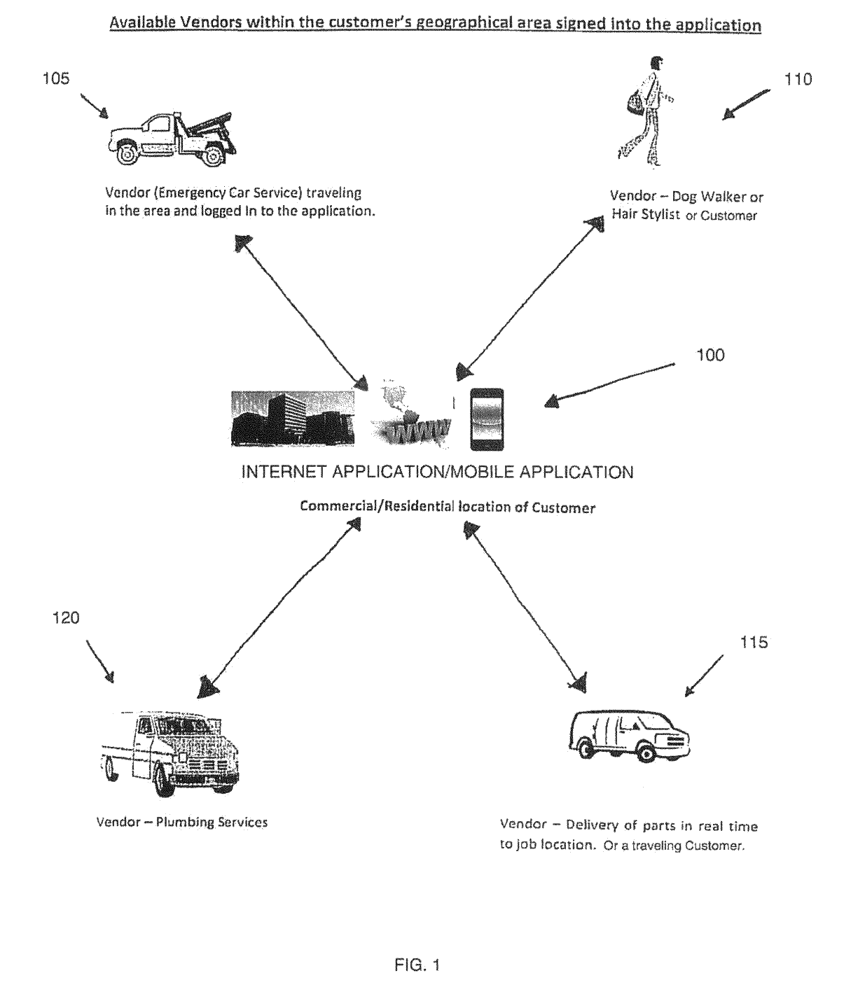

FIG. 1 illustrates a perspective view of an exemplary geographical view of an exemplary software module architecture of a networking platform system, in accordance with an embodiment of the present invention. In one embodiment, networking platform system may enable providing location-based vendor services to mobile and computing devices that are signed into the application. In the present embodiment, a user/customer may log into a network application platform via mobile device or computing device at, but not limited to, locations 100, 105, 110, 115 and 120 and provide for example, but not limited to, their commercial/residential location or business office location. In the present embodiment, vendors and/or customers at locations 100, 105, 110, 115, and 120 may be logged into the network application if their vendor services are available to geographically friendly user/customers. User/customers may then signal vendor service operators for real-time delivery of products and services.

In one embodiment, network application platform may allow any given customer to directly connect with a qualified service vendor in their area for a wide variety of professional needs via computer/tablet/phone application. The network application platform for these services and direct connections to vendors and user/customers may be encompassed in one application. The network application platform may combine a vast amount of, but not limited to, services, different vendors and business offices across different areas of expertise into one single platform, which may be accessed by user/customers via a single application. In some embodiments, the application may be an internet-based application that may allow customers to directly connect with various vendors and business offices across multiple areas of services. The services provided may be received from, but not limited to, governmental, private, and commercial employees, contractors, and vendors to provide, without limitation, both residential and commercial service and product needs.

In one embodiment, user/customers may be connected to vendors based on the geographical location of the customer and their relation to the geographical location of the vendor. The nearest vendor available for providing a service may be first in line to accept the service request if within the geographical radius of the service request.

In one embodiment, a given customer may be able to log into the application and select the type of service he/she requires. Once the customer completes the service request, the application may automatically, in real-time, send the request to the nearest vendor who is qualified to fulfill the customer's request and whom is available for service. As a non-limiting example, the vendor receives said request, accepts the request, and goes to the customer's location in order to ascertain the exact services needed and to quote a price or immediately provide service. In another non-limiting example, traveling customers may connect with nearest available businesses or venders for a visit or to receive services in real-time.

In one embodiment, if certain parts are needed to complete the job, a customer and/or vendor may be able to contact a vendor delivery person, using the network application platform at locations 100, 105, 110, 115 or 120 to deliver said parts to the location of where the job is being performed. In some embodiments, the vendor or business may be able to mark his status on network application platform, as “available” or “unavailable” during any time of the day and night, thereby allowing customers the ability to connect any time of day or night, bypassing any possible off hour emergency or rush fees.

In one embodiment, once the vendor arrives at a job site, he may offer to the client the ability to have their entire interaction digitally recorded via the application. This may only take place with the customer's approval. This may allow the customer and vendor to document and obtain a clear record of for example, but not limited to, their conversations, interactions, and transactions regarding what jobs need to be performed, the time frame for start and completion, and the price quoted. Thus if any issues may arise in the future, both customer and vendor may have access to the digitally recorded documentation. This may ensure the highest quality of service and interactions between user/customers and vendors of networking application platform and for honest ratings.

In other embodiments, the geographical range of user/customers and vendor services providers may be not limited to any distance or operating region. Vendors and user/customers may select an operating distance for servicing and providing products to customers. In a non-limiting example, the range of operability of network application services may extend from one or more feet to a plurality of thousands of miles based upon the user/customers and vendors desired range of operability for vendor services.

In other embodiments, networking application platform may collect geographical location information about user/customers in a private central location database as software on a user's mobile or computing device sends its location using GPS to location-based vendor services platforms at a configurable interval, for example, without limitation, every 10 seconds, every minute, or every five minutes. This geographical information may be the geographical location of the user's mobile or computing device. In the present embodiment, the location database may in a central location where the entity using the system records and owns its personal location database.

In one embodiment, there may be an alternative architecture where each entity that uses the location-based vendor services platform may have its own location database on its own site that stores the location of people that have downloaded the mobile/computing network application vendor software. In yet another embodiment, the location database may be owned by the administrator of the location-based vendor services platform thereby giving them ownership of user/customer geographic location in real-time.

In other embodiments, location-based vendor services platform may be able to send messages to users through their mobile/computing devices, and users may set preferences on their mobile/computing devices to receive messages from particular location based service vendor modules. These preferences may include, without limitation, types of desired services and/or products, geographical radius of location-based vendor services, and timeframe of delivery for services/products. The network application software platform may search a geographical location database for user/customers who are located in service areas based on the location data and the particular module and/or preferences used to perform location-based services.

In other embodiments, the location-based vendor services platform may comprise, without limitation, the following modules: a module to send users/customer information at first request, a chat module for opening a dialogue of mobile/computing communication between vendors and user/customers, a proximity module that provides information to vendors and user/customers through locating the vendor and user/customer's geographic location, a viewing, locating and searching module which may geographically map a plurality of vendors and user/customers, a payment module by which online payments may be sent and received to and from vendors and user/customers, a resource module that may provide additional options for similar services and products, an alert module that may provide signal notifications to vendors and/or user/customers mobile and computing devices, and a protect module that secures transactions and safeguards vendors and/or user/customers private and confidential information. Those skilled in the art, in light of the present teachings, will readily recognize that various different modules may be included in alternate embodiments including, but not limited to, a traffic module which may determine and estimate the delivery time of products or services, a tracking and/or inventory module which may track and record in a central database vendor and user/customer product and services purchase history, and an advertising and/or profiling module which may provide advertisements to vendors and user/customers who have purchased similar services and products.

In another embodiment, chat module may be used to provide services such as, but not limited to, a location-based customer service chat, a service enabling users to talk to friends and colleagues, and a service connecting sellers and buyers in particular locations. In other embodiments, services that may be provided by proximity module include, without limitation, location-based advertising, automatic airport check in, activating a smart house, retrieving crime reports for an area, retrieving home prices, ordering a taxi, etc. In other embodiments, the view module may enable users to view where other users are located, in addition to providing views of where vendors are located. Services that may be provided by view module include, without limitation, a service for finding friends and colleagues, a mobile dating service and a social or business networking service. In one embodiment, the resource module may enable users to track resources such as, but not limited to assets, employees, children, etc. In other embodiments, the alert module provides important information and alerts based on geographic location such as, but not limited to, traffic accidents, weather warnings, earthquake warnings, notification if a user's children are near a criminal, etc. In other embodiments, the protect module generally prevents credit card or financial fraud by matching the geographic location of a user with the location of a purchase or other activity involving the user's credit card or bank account. If the location of the user as indicated in location database is not the same as the location of the purchase or account activity, the chance of fraud is much higher. Furthermore, companies who have installed location-based vendor services network application may make their own applications for their customers such as, but not limited to, special pricing and discounts and coupons, back-ordered product inventory lists, special events, operating hours, and supporting suppliers.

In some embodiments, network application platform 100 may be integrated with business intelligence solutions, and data quality providers such as, but not limited to, Cognos (IBM), Microstrategy, Information Builders, Business Objects/SAP, Teradata, Informatica, Hyperion/Oracle, SPSS, etc. Also in some embodiments, network application platform 100 may be integrated with other data integration/enterprise application integration solution providers such as, but not limited to, BEA/Oracle, Web Methods/Software AG, Websphere/IBM, Teradata, Informatica, Tibco and Information Builders. This may enable network application platform 100 to leverage technology that has been developed and perfected rather than building new integration in to all of the different databases in the system. This integration may allow for the system to integrate customer location information with all the other information data entities have about the customer. It may create a virtual real time “golden record” of each customer. In a non-limiting example, the system may know the products the customer has purchased, what stores the customer frequents, etc. and be able to provide true one to one marketing and information based on location while providing that information at the right and relevant time. However, in alternate embodiments new integration may be built into the databases of the system rather than using pre-existing integration solutions.

In other embodiments, a strengthened solution may be the ability for a vendor or user/customer to locate an available vendor or user/customer at any time of day or night, and connect with the particular vendor or user/customer who chooses to work at any time. By way of example, without limitation, an individual may be in need of a qualified, affordable and trustworthy service and may not have the time or expertise to select the correct company to complete the given task, or operation. The individual, or user/customer, may then access a network application platform that allows an individual or user/customer to directly connect and communicate with qualified vendors over a wide area of expertise to receive services.

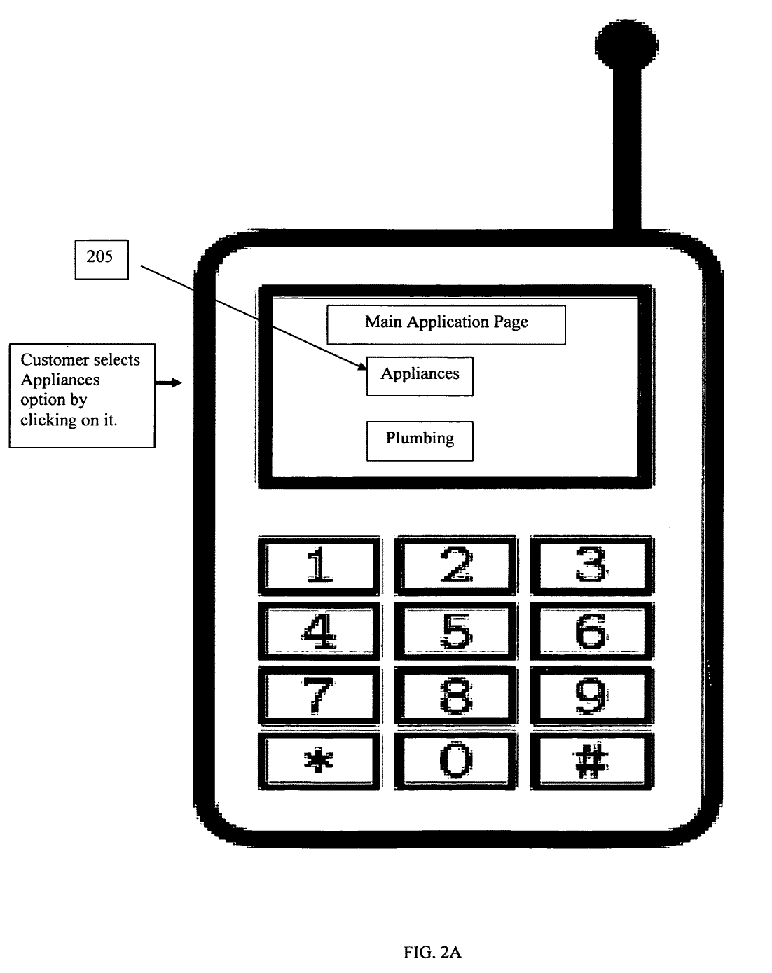

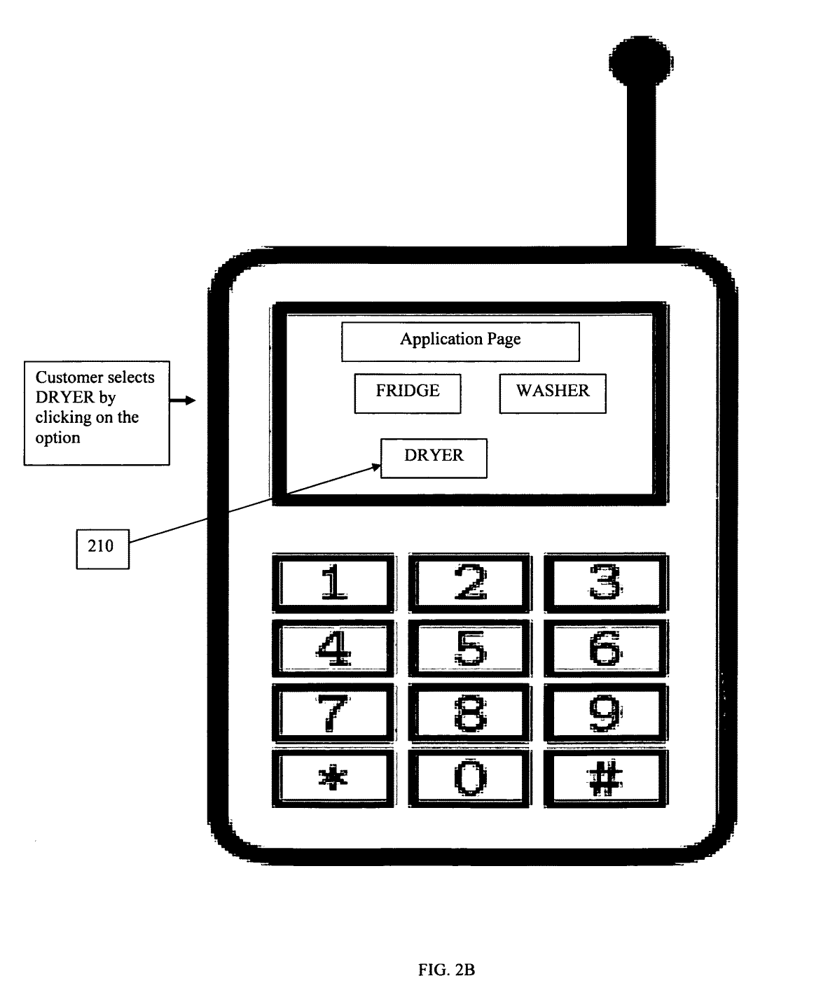

FIGS. 2A and B illustrate an exemplary software module architecture of a system for networking application platform that enables the delivery of services, material/tool and products, in accordance with an embodiment of the present invention. In some embodiments, a user/customer may select from a mobile or computing device, for example, without limitation, a touch-screen or touch-button selection that selects an appliance or plumbing option 205 whereby networking application may provide options for specific types of appliances desired to receive services. In some embodiments, for example, without limitation, the user/customer may provide more details information on the type services needed to find correct vendor for job by selecting display options 210 for fridge, dryer or washer to provide a list of available vendor operators within user/customers geographical region to send a request for service, get information, service or provide materials/tools and products to complete any given job.

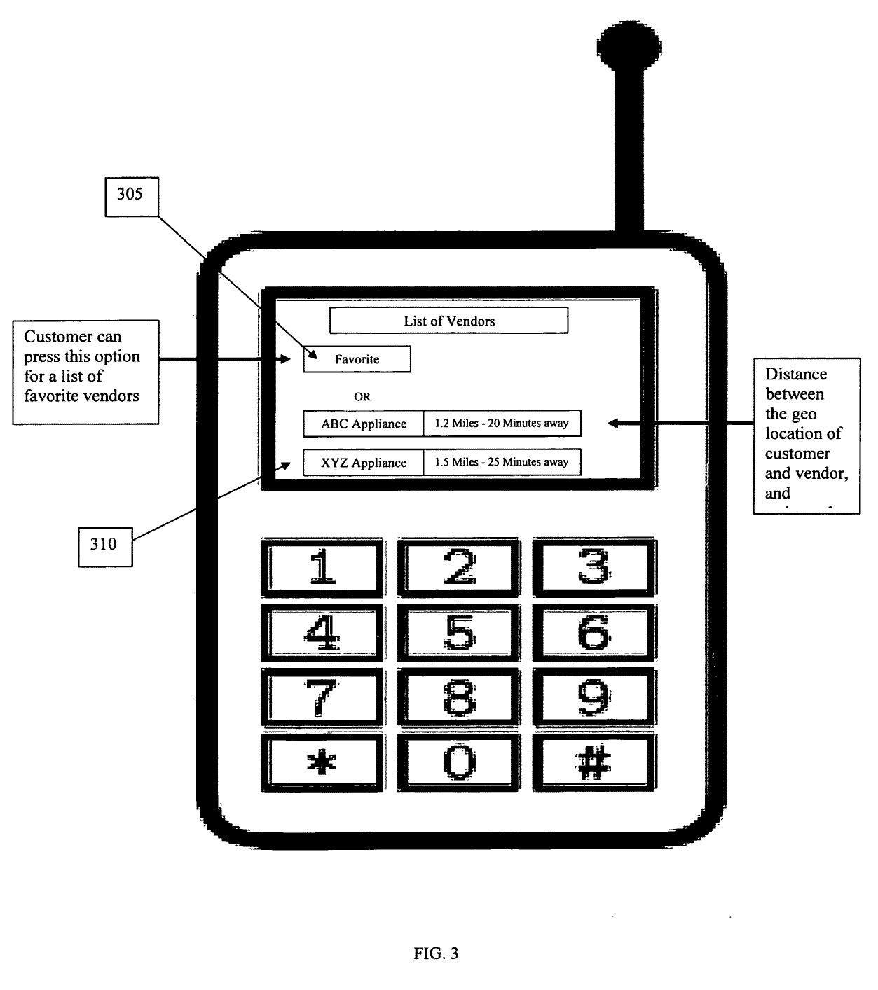

FIG. 3 illustrates an exemplary software module architecture of a system for networking application platform that enables a user/customer to select recommended options for their service desired, in accordance with an embodiment of the present invention. In the present embodiment, the user/customers of network application platform may select or press the favorites display option 305 for a list of favorite vendors that are located geographically. In the present embodiment, a favorite vendor list may be provided within network application platform which may allow an option to display user/customers favorite vendors in ascending/descending, ranked, or geographical order, based upon the request and whether the vendor(s) are available at the time the customer needs the job completed. In other embodiments, a user/customer and/or vendor may determine the distance between a user/customer 310 and/or vendor in order to determine the feasibility of timeframe of delivery of services required and/or products delivered. In other embodiments, the networking application platform may allow a traveling user/customer and/or vendor to immediately find an availability list structure of vendors with the earliest (open schedule window) appointment availability within the geographical area or region they are traveling in. This may include, without limitation, such vendors as car repair shops, dentists, doctor's offices, plumbers, electricians, contractors, commodity and/or money and market management companies, etc.

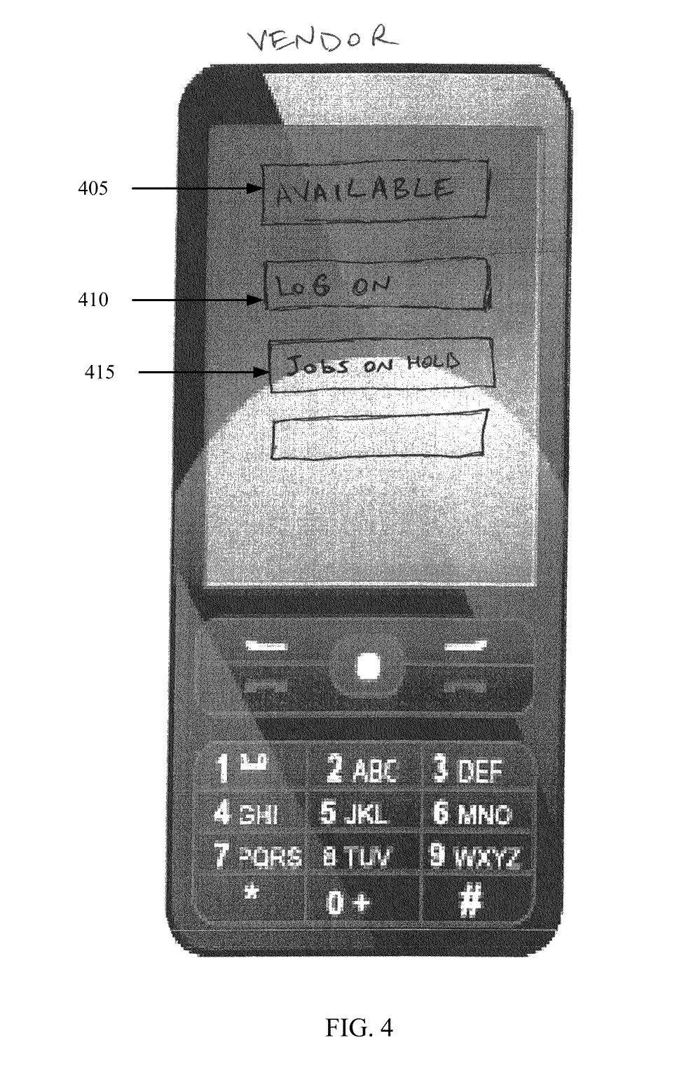

FIG. 4 illustrates an exemplary software module architecture of a system for networking application platform that enables individuals or a plurality of websites to perform location-based vendor services, in accordance with an embodiment of the present invention. In the present embodiment, vendor may mark 405 their status as “available” or “unavailable” during any time of the day and night, thus allowing user/customers the ability to connect even during the off hours, thereby bypassing any possible off hour emergency, service call, or rush fees. In the present embodiment, the vendor may log on 410 to the networking application platform. In the present embodiment, the vendor may view any jobs on hold 415 or place unfinished jobs on hold. In other embodiments, the networking application platform may allow any independent vendors/business to be able to join the network in any location and their area of their expertise and discipline if they choose. Thus, all independent vendors/companies may be able to receive jobs according to their specialties.

In other embodiments, users of website networking application platform may be for example, without limitation, buyers, sellers, and retailers of various items. In one example, but not limited to, users may enter information on website about the items they want to sell or what they want to buy along with a radial distance threshold which may be geographically centered.

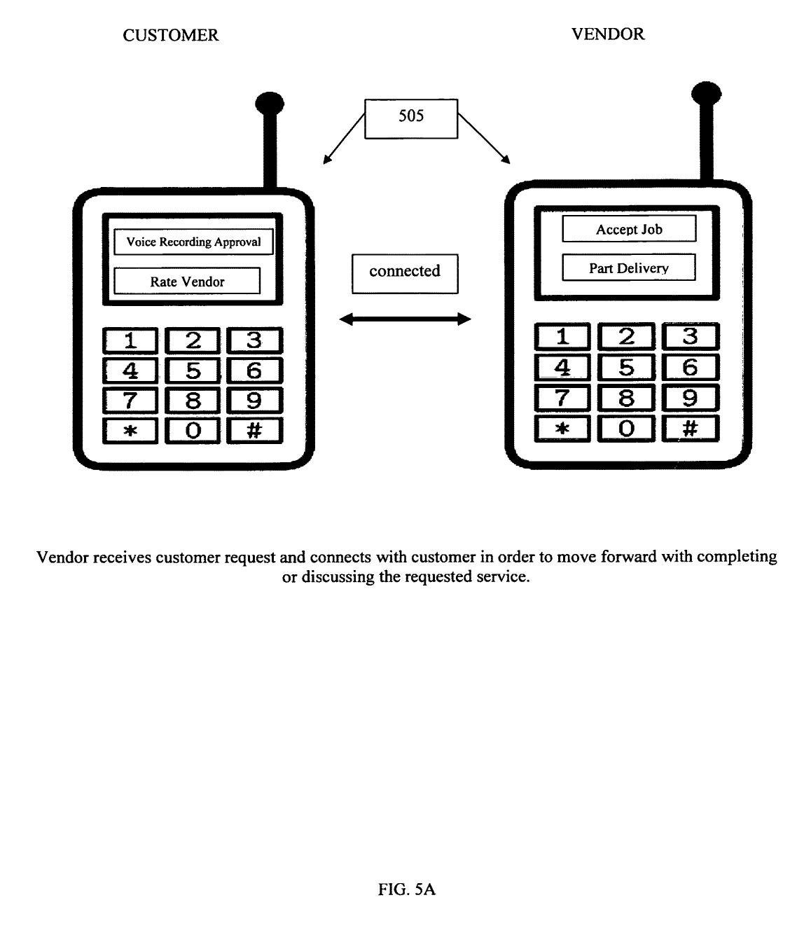

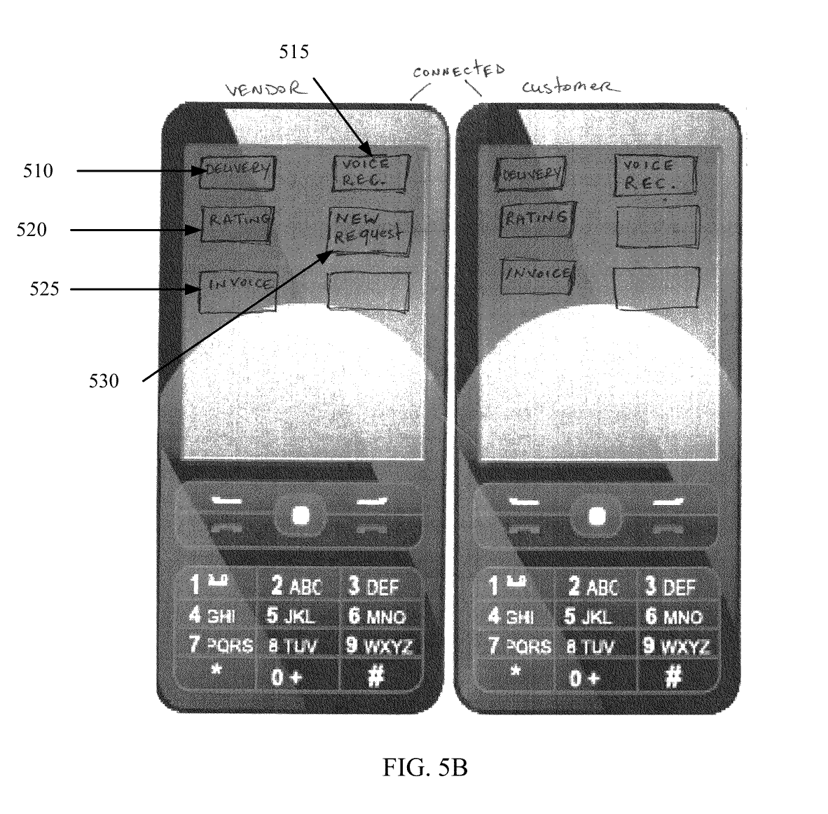

FIGS. 5A and 5B illustrate an exemplary software module architecture of a system for networking application platform that enables geographically based buyers and sellers to match criteria of what they are looking to sell or buy, in accordance with an embodiment of the present invention. In some embodiments, the system for networking application platform may enable a buyer and a seller match the criteria of what they are looking to sell or buy, and both lie within the proper radial distance threshold of each other. In the present embodiment, a message is sent to the mobile/computing devices for both the seller and the buyer, and/or vendor and user/customer, and/or retailer 505. The users may then open a chat or call each other to possibly make a transaction regarding products or services capabilities. The website of location-based vendor services network application platform may integrate location and time and distance when matching up customers with a vendors for services or buyers and sellers for specific products and services anywhere in the world. Users of website may also provide various other types of location-based vendor services such as, but not limited to, quick solution for service, social networking, posting personal and classified ads, streaming of data content, vendor and user/customer advertisements, etc. Alternate embodiments may not comprise a website enabling user/customers to perform their own location-based vendor services.

In the present embodiment user/customer and/or vendor may be able to use the same networking application to order and deliver materials 510 promptly, or in near real-time. In other embodiments the system for networking application platform 510 enables the delivery of necessary materials/tools and products to complete any given job, after the initial inspection and diagnosis from the vendor. In some embodiments, a user/customer and/or vendor may be able to choose an optional recording 515 of the service and/or product interaction between the user/customer and/or vendor, which may ensure a higher quality level of performance, and quality control, between interactions involving two or more parties. In some embodiments, the user/customers may rate or rank vendors 520 on their ability, knowledge, cleanliness, costs, efficiency and timeframe. In some embodiments, user/customer and/or vendor may receive or send an invoice 525. In other embodiments, the vendor may be able to accept additional jobs 530 from the same customer, or multiple customers from different job sites, while on location.

In some embodiment, there may be the ability to directly connect vendor and user/customer within the same geographical area or region within real-time. The vendors may provide service over a wide array of specialties and expertise. The vendor and/or user/customer may be able to order parts/materials in real-time and have them delivered, without limitation, to a residence, commercial property or business, or a job site in time to complete the service requested, while the vendor or user/customer is still working at the customer's job-site location. This way customer may receive service and job done right away and may save time for the user/customer by not having to call or research a plurality of different companies for their availability and schedules, rates, fees, service locations, consumer reports, rankings, business standings, and employees, without limitation.

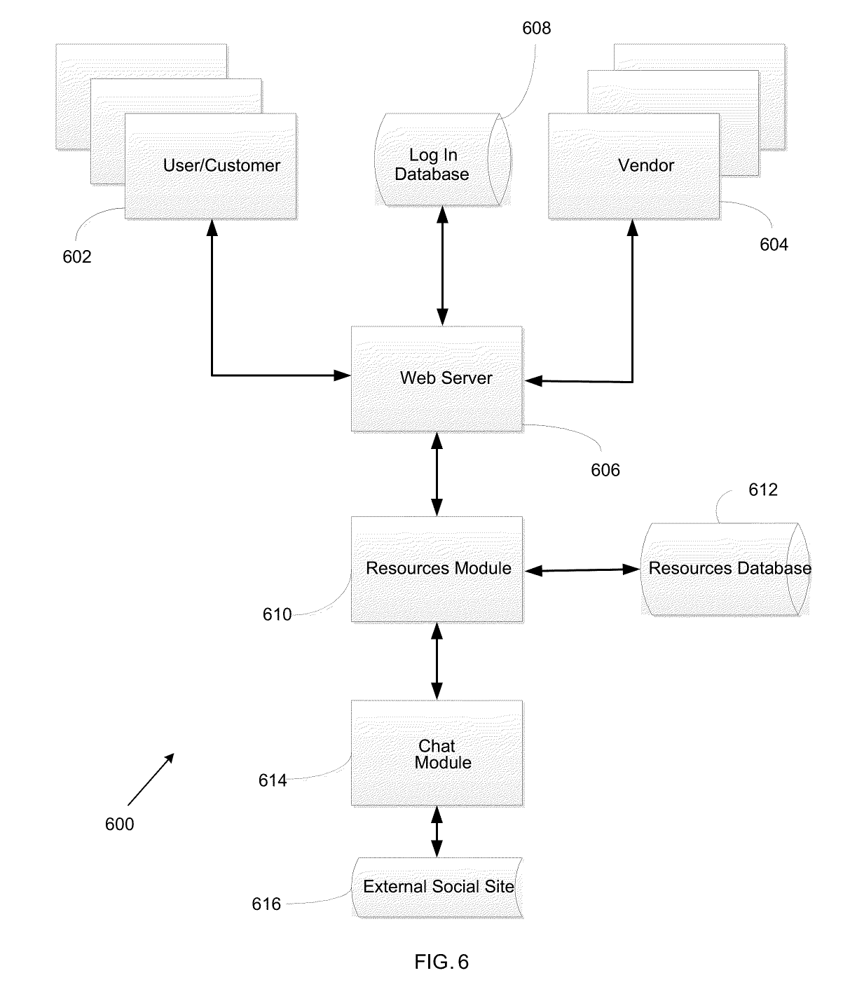

FIG. 6 illustrates an exemplary software module architecture of a system for networking application platform that enables user/customers and vendors to communicate about projects and services, in accordance with an embodiment of the present invention.

In some embodiments, a given user/customer 602 or vendor 604 may be able to log into the application and select the type of service he/she requires via log in database 608. Once the customer completes the service request, the application may automatically, in real-time via web server 606, send the request with necessary information to the nearest vendor who may be qualified to fulfill the customer's request and whom may be available to except the request right away and to able to head out to customers location to perform the job. Resources module 610 and resources database 612 may receive and records service requests and may also displays available resources with the geographical region based upon user/customer and/or vendors services preferences. Resources module 610 and resources database 612 may also provide additional options for similar services and products based upon services preferences.

In some embodiments, vendor 604 may receive the request, accept the request, and goes to the user/customer's 602 location in order to ascertain the exact services needed and to quote a price or immediately provide services.

In some embodiments, chat module 614 may provide a means for opening a real time dialogue of mobile/computing communication between vendors and user/customers to discuss and negotiate services being sought. External social site 616 may provide an interactive way to socialize and communicate service based issues. In other embodiments, web server 606 may provide vendors and user/customers to exchange information to contact each other via a phone call.

In some embodiments, a given user/customer 602 or vendor 604 may be able to register and log into the application via log in database 608 and select the type of service he/she requires. Resources module 610 and resources database 612 may allow, without limitation, user/customers and vendors to have the ability to review and modify past/present inventory levels and services being conducted and completed. Chat module 614 may allow user/customers and vendors the ability to exchange data or any information related job online using External social site 616.

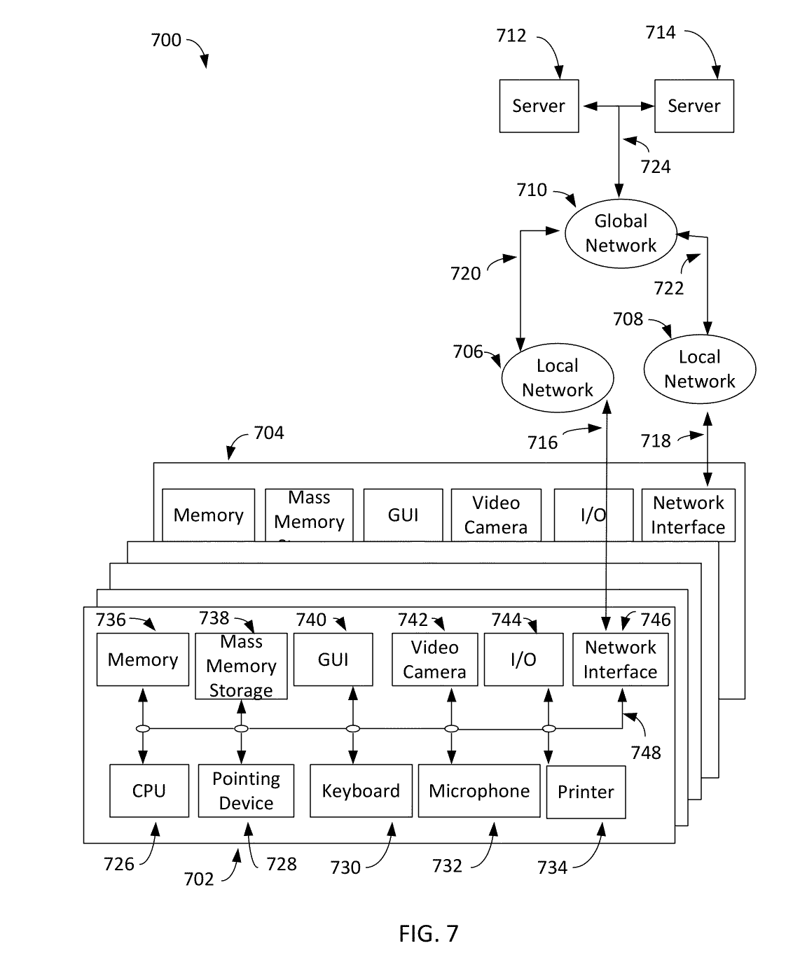

FIG. 7 illustrates an exemplary software module architecture of a system for networking application platform for a web-enabled/networked application platform that enables a client/server system may be used in accordance with an embodiment of the present invention.

In some embodiments, Communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

In other embodiments, Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In other embodiments, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

In other embodiments, Clients 702 and 704 may take many different forms. Non-limiting examples of clients 702 and 704 include personal computers, personal digital assistants (PDAs), cellular phones and smartphones.

In one embodiment, Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

In one embodiment, CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

In one embodiment, CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

In one embodiment, CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

In yet another embodiment, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

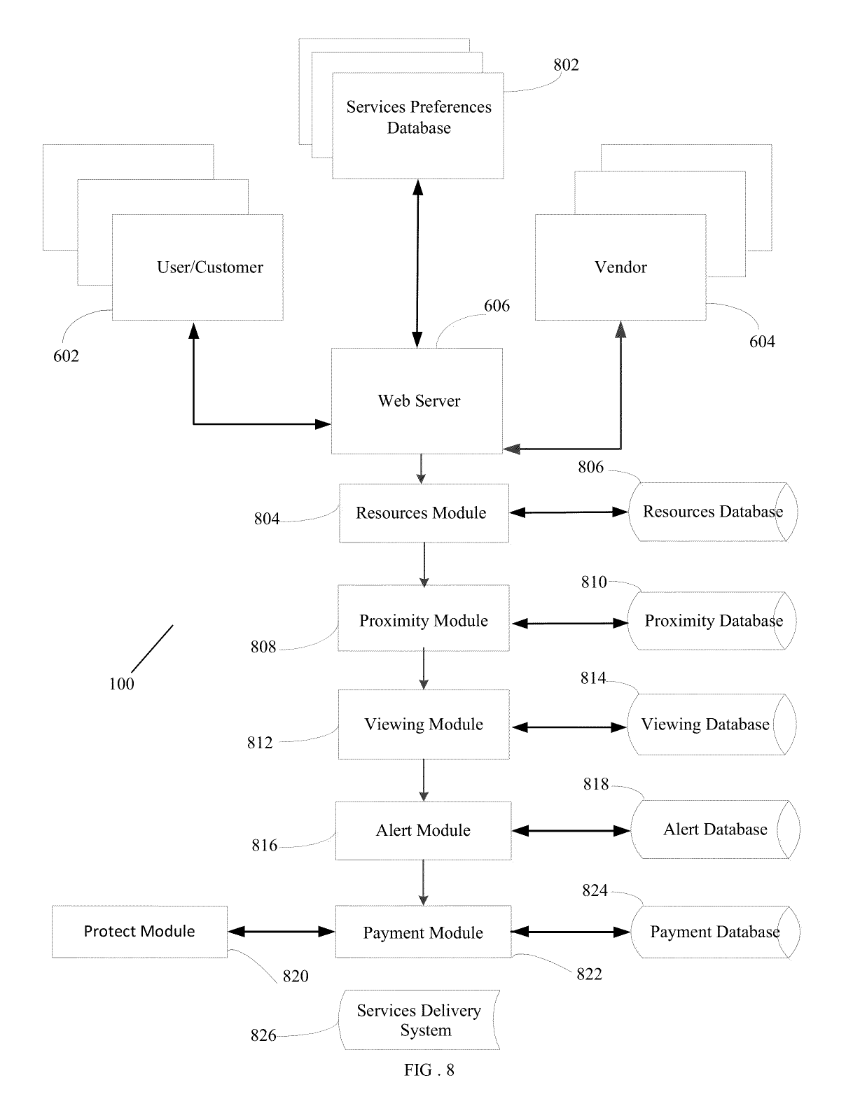

FIG. 8 illustrates an exemplary software module architecture of a system for networking application platform depicting a services delivery system, in accordance with an embodiment of the present invention.

In one embodiment, user/customers and vendors may be profiled for services based upon chosen preferences by which user/customers and vendors. In the present embodiment, location-based vendor services platform network application 100 may utilize resources module 804 and resources database 806 to notify user/customer 602 or vendor 604 of services available or needed based upon preferences chosen within the services preference database 802. Proximity module 808 and proximity database 810 may determine and display the geographical locations of user/customers and vendors with the specified region of serviceability. Viewing module 812 and viewing database 814 may provide a means for viewing geographically mapped locations of a plurality of vendors and user/customers. An alert module 816 and alert database 818 may provide signal notifications to vendors and/or user/customers mobile and computing devices. Protect module 820 and payment module 822 and payment database 824 may provide a secure means for transactions by which online payments may be sent and received to and from vendors and user/customers while safeguarding vendors and user/customers private and confidential information. Services delivery system 826 may log and record all transactions and services currently being performed in addition to past transactions and services performed. In some embodiments, venders may have credit/debit card readers and/or means for capturing a check for receiving payment.

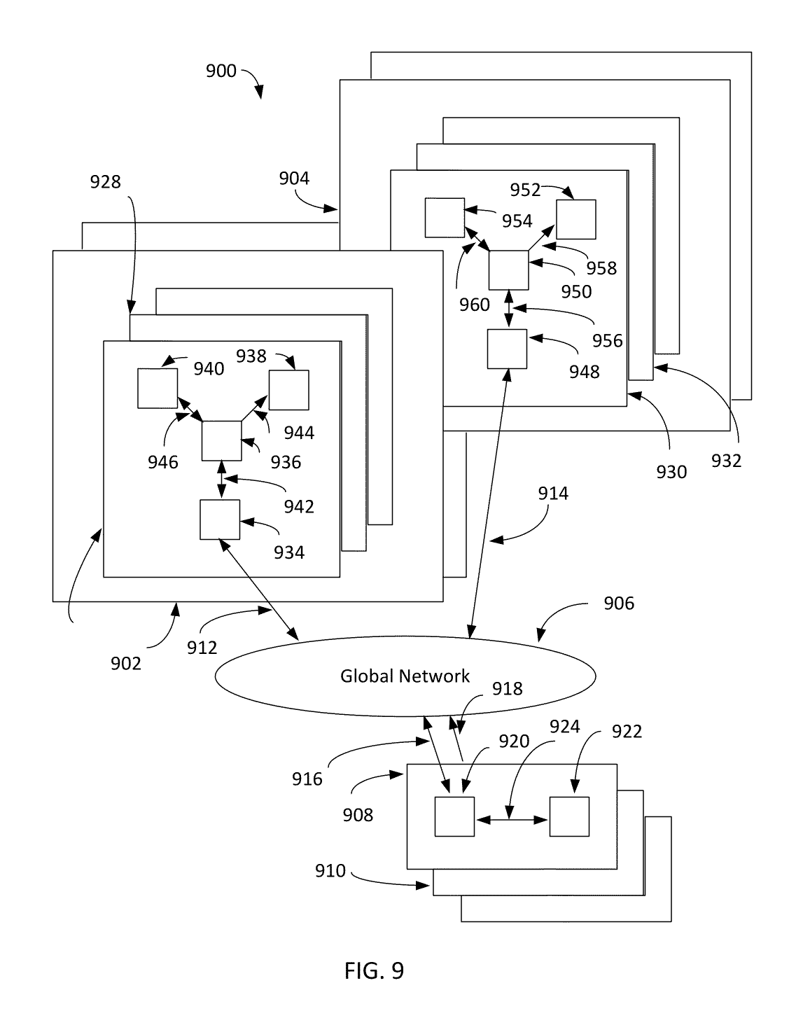

FIG. 9 illustrates an exemplary software module architecture of a system for networking application platform depicting a conventional client/server communication system, in accordance with an embodiment of the present invention.

In one embodiment, communication system 900 includes a multiplicity of networked regions with a sampling of regions denoted as a network region 902 and a network region 904, a global network 906 and a multiplicity of servers with a sampling of servers denoted as a server device 908 and a server device 910.

In the present embodiment, network region 902 and network region 904 may operate to represent a network contained within a geographical area or region. Non-limiting examples of representations for the geographical areas for the networked regions may include postal zip codes, telephone area codes, states, counties, cities and countries. Elements within network region 902 and 904 may operate to communicate with external elements within other networked regions or within elements contained within the same network region.

In one embodiment, global network 906 may operate as the Internet. It will be understood by those skilled in the art that communication system 900 may take many different forms. Non-limiting examples of forms for communication system 900 include local area networks (LANs), wide area networks (WANs), wired telephone networks, cellular telephone networks or any other network supporting data communication between respective entities via hardwired or wireless communication networks. Global network 906 may operate to transfer information between the various networked elements.

In other embodiments, server device 908 and server device 910 may operate to execute software instructions, store information, support database operations and communicate with other networked elements. Non-limiting examples of software and scripting languages which may be executed on server device 908 and server device 910 include C, C++, C# and Java.

In other embodiments, network region 902 may operate to communicate bi-directionally with global network 906 via a communication channel 912. Network region 904 may operate to communicate bi-directionally with global network 906 via a communication channel 914. Server device 908 may operate to communicate bi-directionally with global network 906 via a communication channel 916. Server device 910 may operate to communicate bi-directionally with global network 906 via a communication channel 918. Network region 902 and 904, global network 906 and server devices 908 and 910 may operate to communicate with each other and with every other networked device located within communication system 900.

In one embodiment server device 908 includes a networking device 920 and a server 922. Networking device 920 may operate to communicate bi-directionally with global network 906 via communication channel 916 and with server 922 via a communication channel 924. Server 922 may operate to execute software instructions and store information.

In one embodiment, network region 902 includes a multiplicity of clients with a sampling denoted as a client 926 and a client 928. Client 926 includes a networking device 934, a processor 936, a GUI 938 and an interface device 940. Non-limiting examples of devices for GUI 938 include monitors, televisions, cellular telephones, smartphones and PDAs (Personal Digital Assistants). Non-limiting examples of interface device 940 include pointing device, mouse, trackball, scanner and printer. Networking device 934 may communicate bi-directionally with global network 906 via communication channel 912 and with processor 936 via a communication channel 942. GUI 938 may receive information from processor 936 via a communication channel 944 for presentation to a user for viewing. Interface device 940 may operate to send control information to processor 936 and to receive information from processor 936 via a communication channel 946. Network region 904 includes a multiplicity of clients with a sampling denoted as a client 930 and a client 932. Client 930 includes a networking device 948, a processor 950, a GUI 952 and an interface device 954. Non-limiting examples of devices for GUI 938 include monitors, televisions, cellular telephones, smartphones and PDAs (Personal Digital Assistants). Non-limiting examples of interface device 940 include pointing devices, mousse, trackballs, scanners and printers. Networking device 948 may communicate bi-directionally with global network 906 via communication channel 914 and with processor 950 via a communication channel 956. GUI 952 may receive information from processor 950 via a communication channel 958 for presentation to a user for viewing. Interface device 954 may operate to send control information to processor 950 and to receive information from processor 950 via a communication channel 960.

For example, consider the case where a user interfacing with client 926 may want to execute a networked application. A user may enter the IP (Internet Protocol) address for the networked application using interface device 940. The IP address information may be communicated to processor 936 via communication channel 946. Processor 936 may then communicate the IP address information to networking device 934 via communication channel 942. Networking device 934 may then communicate the IP address information to global network 906 via communication channel 912. Global network 906 may then communicate the IP address information to networking device 920 of server device 908 via communication channel 916. Networking device 920 may then communicate the IP address information to server 922 via communication channel 924. Server 922 may receive the IP address information and after processing the IP address information may communicate return information to networking device 920 via communication channel 924. Networking device 920 may communicate the return information to global network 906 via communication channel 916. Global network 906 may communicate the return information to networking device 934 via communication channel 912. Networking device 934 may communicate the return information to processor 936 via communication channel 942. Processor 996 may communicate the return information to GUI 998 via communication channel 944. User may then view the return information on GUI 938.

Network application platform 100 network application platform 100 network application platform 100

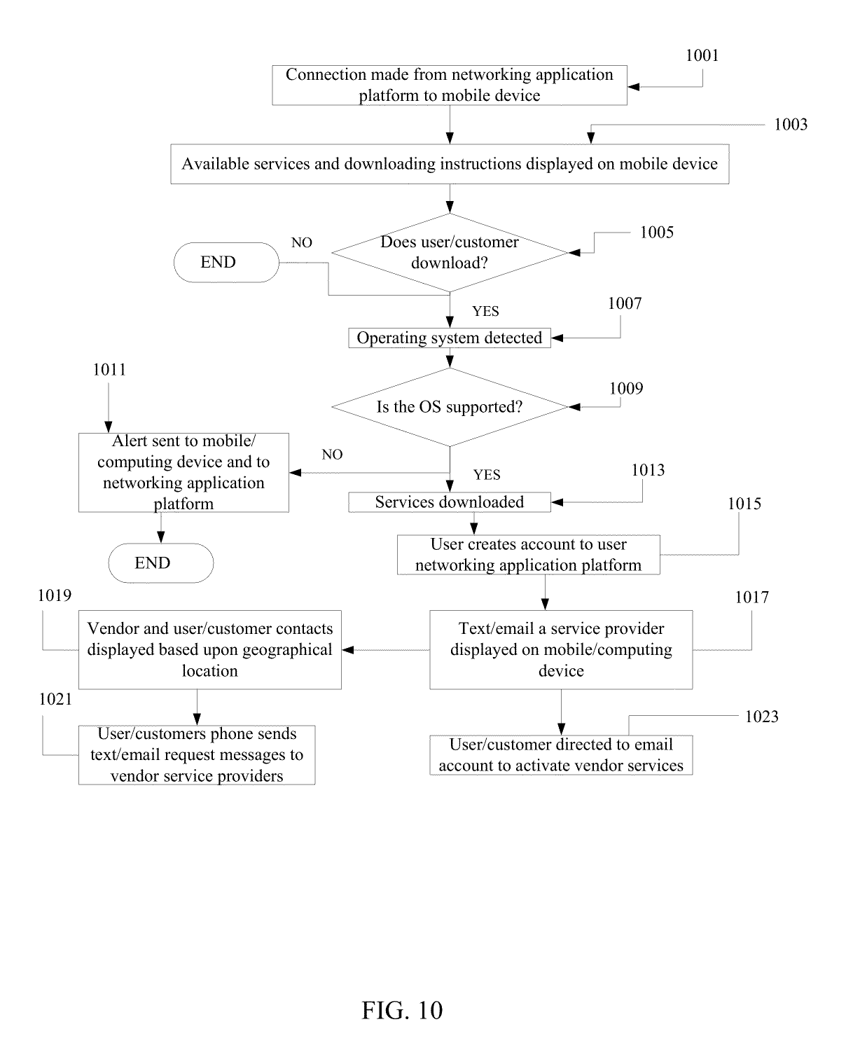

FIG. 10 is a flow chart illustrating an exemplary process for signing up for a location-based vendor service provider, in accordance with an embodiment of the present invention. In the present embodiment, the process begins at a step 1001 where a connection is made from a location-based networking application services platform to a mobile device, for example, without limitation, an over the air (OTA), universal serial bus (USB), Bluetooth or infrared (IR) connection. In a non-limiting example, a user/customer may be able to install the software from a mobile device via Bluetooth. In a non-limiting example, if the software is installed on a friend's mobile device, the user can connect to his friend's phone and receive the software or begin the installation process from him through the Bluetooth connection. Through this connection the services available to the user from the network application platform and instructions on how to download the services may be displayed on the screen of the mobile device in a step 1003. The process may determine if the user chose to download the services in a step 1005. If not, the process may end. If so, the network application platform may auto-detect the operating system (OS) on the mobile device in a step 1007. In a step 1009 the location-based networking application services platform may determine if the OS of the mobile device is supported. If the OS is not supported a message may be sent to the mobile/computing device and to the networking application site of the unsupported OS for administrative tracking in a step 1011, and the process may end. A non-limiting exemplary message that may be sent to the mobile/computing device is “We are sorry but your device is not currently supported. A message has been sent to the developers, and we will work to make this service available.” If the OS is supported, the service may be downloaded in a step 1013.

Once downloaded, the user/customer may enter an email address to create an account to use the secure website connected to the location-based networking application platform services platform in a step 1015. Then in a step 1017 a text/email to/from a service provider message may be displayed on the mobile/computing device that asks the user if he would like to text his vendors/friends about services provided. In the present embodiment, the text/email a service provider/friend feature may be built into the software when the user originally downloads the service in a step 1013, however, alternate embodiments may not comprise a text a friend feature. If the user/customer chooses to text/email service providers/friends in a step 1017, the mobile/computing device networking application platform software may automatically extract the entire list of the contacts in the mobile/computing device and the user is asked to choose which contacts he would like to text/email or which contacts he would not like to text/email or let the software text everyone in a step 1019 based upon geographical location. The text message informing vendors/friends of the user/customer may be sent from the user's phone directly in a step 1021. The user/customer may be given an incentive to text/email his friends about services, for example without limitation, a bathroom or kitchen renovation, or plumbing repairs, or replacing a roof or A/C system. In some embodiments the mobile/computing device networking application software may automatically ask the user/customer at a specified interval, for example, without limitation, every 6 weeks, if he would like to text/email his vendors/friends again about the service. In other embodiments, the user/customer may be only asked once if he would like to text/email his friends. In the present embodiment after the contact information is sent in a step 1021 or if the user/customer chooses not to text his vendors/friends in a step 1017, a message may be sent to the mobile/computing device instructing/directing the user to go to his email to activate his account and create a password in a step 1023. The user/customer may now be able to use the services offered by the location-based networking application services platform.

Those skilled in the art, in light of the present teachings, will readily recognize that the steps described in the previous process may be performed in a different order and in some cases steps may be omitted or added. For example, without limitation, some embodiments may not implement a text a friend sequence. Also, the user may be asked to create a password at the same time that the account is created rather than later in the process. In alternative embodiments, the software can be installed to send location data to the server, and the user can interact with the system without setting up a username and password on the web site.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: recommended vendor action services via social media combined with vendor/operator management programs which result in vendor-customer satisfaction and return business, vendor management of a plurality of suppliers and distributors, network planning, design, optimization, and integration and applications support services to deliver innovative customer solutions.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, those skilled in the art may recognize apparent, other equivalent, or alternative methods of implementing vendor services which may generally relate to direct, location-based, customer/vendor connectivity and interactive services, according to the present invention. Various aspects of the invention have been described above by way of illustration, and the specific embodiments disclosed are not intended to limit the invention to the particular forms disclosed. The particular implementation of the direct, location-based, customer/vendor connectivity and interactive services may vary depending upon the particular context or application. By way of example, and not limitation, the direct, location-based, customer/vendor connectivity and interactive services described in the foregoing were principally directed to vendor service implementations; however, similar techniques may instead be applied to the following services and structures: competitor/vendor comparison analyses, clinical services, manufacturing services, R&D departments, drug delivery services, vendor management of a plurality of suppliers and distributors, network planning, design, optimization, and integration and applications support services to deliver innovative customer solutions. Similar techniques may instead also be applied to the following services and structures: Merging professional and technical services together in the support of customer-based managed service engagements, recommended vendor action services via social media combined with vendor/operator management programs which result in vendor-customer satisfaction and return business, mobile services capabilities which may provide access to a level of service customization, cloud computing vendor management capabilities to assist with the identification and preservation of potentially relevant electronically stored information (“ESI”) and reviews of such information by which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
connecting to an application platform comprising a plurality of modules being configured to at least network a plurality of clients for a plurality of vendors;
submitting to said application platform a request for a service, said request at least comprising a customer's identity, a location for said service and a type of said service, said application platform at least determining a list of available vendors for said service, said list of vendors comprising vendors being located within a geographical distance from said location;
receiving from said application platform said list for display to the customer;
submitting a customer's choice of a vendor to provide said service to said application platform, said application platform communicating said request to a client of the chosen vendor and facilitating communication between the customer and the chosen vendor, wherein, upon agreement between the customer and the chosen vendor, the chosen vendor dispatches to said location; and
submitting to said application platform a request for materials needed by the vendor to complete said service, said materials being dispatched to said location while the vendor is at said location.

2. The method as recited in claim 1, in which said application platform accepts requests from commercial and residential customers.

3. The method as recited in claim 1, in which clients of the vendors on said list are in communication with said application platform to receive a request.

4. The method as recited in claim 1, in which a client of a vendor communicates a status of unavailable for exclusion from said list.

5. The method as recited in claim 1, further comprising the step of submitting to said application platform a customer's choice for a favorite vendor, wherein said favorite vendor is placed first on said list.

6. The method as recited in claim 5, in which submitting a choice of said favorite vendor initiates a direct connection to said favorite vendor.

7. The method as recited in claim 1, submitting to said application platform a request to record interactions between the customer and the chosen vendor.

8. The method as recited in claim 1, in which geographical locations of the vendors are determined by locations of said clients of the vendors.

9. The method as recited in claim 1, in which said application platform is further configured for processing payment upon completion of said service.

10. A method comprising:
steps for connecting to an application platform configured to at least network a plurality of clients for a plurality of vendors;
steps for submitting a request for a service at a location;
steps for receiving from said application platform a list of available vendors for said service for display to a customer;
steps for submitting a customer's choice of a vendor to provide said service, wherein, upon agreement between the customer and the chosen vendor, the chosen vendor dispatches to said location; and
steps for submitting a request for materials needed by the vendor to complete said service, said materials being dispatched to said location while the vendor is at said location.

11. The method as recited in claim 10, further comprising steps for submitting a customer's choice for a favorite vendor.

12. A non-transitory computer-readable storage medium with an executable program stored thereon, wherein the program instructs one or more processors to perform the following steps:
connecting to an application platform comprising a plurality of modules being configured to at least network a plurality of clients for a plurality of vendors;
submitting to said application platform a request for a service, said request at least comprising a customer's identity, a location for said service and a type of said service, said application platform at least determining a list of available vendors for said service,
said list of vendors comprising vendors being located within a geographical distance from said location;
receiving from said application platform said list for display to the customer;
submitting a customer's choice of a vendor to provide said service to said application platform, said application platform communicating said request to a client of the chosen vendor and facilitating communication between the customer and the chosen vendor, wherein, upon agreement between the customer and the chosen vendor, the chosen vendor dispatches to said location; and
submitting to said application platform a request for materials needed by the vendor to complete said service, said materials being dispatched to said location while the vendor is at said location.

13. The program instructing the one or more processors as recited in claim 12, in which said application platform accepts requests from commercial and residential customers.

14. The program instructing the one or more processors as recited in claim 12, in which clients of the vendors on said list are in communication with said application platform to receive a request.

15. The program instructing the one or more processors as recited in claim 12, in which a client of a vendor communicates a status of unavailable for exclusion from said list.

16. The program instructing the one or more processors as recited in claim 12, further comprising the step of submitting to said application platform a customer's choice for a favorite vendor, wherein said favorite vendor is placed first on said list.

17. The program instructing the one or more processors as recited in claim 16, in which submitting a choice of said favorite vendor initiates a direct connection to said favorite vendor.

18. The program instructing the one or more processors as recited in claim 12, submitting to said application platform a request to record interactions between the customer and the chosen vendor.

19. The program instructing the one or more processors as recited in claim 12, in which geographical locations of the vendors are determined by locations of said clients of the vendors.

20. The program instructing the one or more processors as recited in claim 12, in which said application platform is further configured for processing payment upon completion of said service.
